(19) United States
(12) Patent Application Publication
(10) Pub. No.: US 2013/0257706 A1
(43) Pub. Date: Oct. 3, 2013

(54) BACKLIGHT DRIVING CIRCUIT AND METHOD

(71) Applicant: ILI TECHNOLOGY CORPORATION, Jhubei City (TW)

(72) Inventors: Ming-yu TSAI, Kaohsiung City (TW); Tai-Yuan CHEN, Miaoli County (TW); Chien-Kuo WANG, Hsinchu City (TW)

(73) Assignee: ILI TECHNOLOGY CORPORATION, Jhubei City (TW)

(21) Appl. No.: 13/657,982

(22) Filed: Oct. 23, 2012

(30) Foreign Application Priority Data
Mar. 29, 2012 (TW) 101111109

(51) Int. Cl. G09G 3/34

(52) U.S. Cl. CPC G09G 3/3426
USPC 345/102

(57) ABSTRACT

A backlight driving circuit includes a scan driver operatively associated with pixel circuits in a matrix formation, and a backlight driver. The scan driver activates the pixel circuits in a row-by-row manner within a frame interval for provision of data voltages to the pixel circuits in each row of the matrix formation, respectively. The backlight driver adjusts a duty cycle of a backlight driving signal for a backlight source such that the backlight source is deactivated when at least one of the pixel circuits is yet to be activated within the frame interval, and adjusts the duty cycle to gradually increase brightness of light output from the backlight source when all of the pixel circuits have been activated within the frame interval.

### CROSS-REFERENCE TO RELATED APPLICATION

This application claims priority of Taiwanese Application No. 101111109, filed on Mar. 29, 2012.

### BACKGROUND OF THE INVENTION

1. Field of the Invention

The present invention relates to a driver, and more particularly to a backlight driving circuit and method.

2. Description of the Related Art

In a liquid crystal display (LCD) device, each pixel circuit is driven at every frame interval by a data voltage to adjust a twist angle of a liquid crystal particle to which the pixel circuit is operatively associated. However, since transition of the liquid crystal particle from one state to another needs a period of liquid crystal response time for completion, if the backlight remains “ON” during the transition, a residual image phenomenon may occur.

A technique to alleviate the aforesaid problem includes turning on the backlight only after transition has been completed and prior to the next transition. Although the residual image phenomenon may thus be alleviated, image flickering may arise. In view of the above, several techniques, including dimming the backlight or turning on the backlight shortly before completing transition, have been proposed. However, the effects achieved thereby in terms of image quality are rather limited.

### SUMMARY OF THE INVENTION

Therefore, an object of the present invention is to provide a backlight driving circuit and method capable of alleviating both image flickering and residual image phenomenon.

According to one aspect of the invention, a backlight driving circuit is adapted for receiving a plurality of data voltages and is adapted to be connected electrically to a backlight source and to a plurality of pixel circuits that are arranged in a matrix formation. The backlight driving circuit comprises a scan driver and a backlight driver.

The scan driver is configured to be operatively associated with the pixel circuits and is configured to activate the pixel circuits in a row-by-row manner within a frame interval for provision of the data voltages to the pixel circuits in each row of the matrix formation, respectively.

The backlight driver is configured to be operatively associated with the backlight source, is configured to adjust a duty cycle of a backlight driving signal for the backlight source such that the backlight source is deactivated when at least one of the pixel circuits is yet to be activated by the scan driver within the frame interval, and is configured to adjust the duty cycle of the backlight driving signal to gradually increase brightness of light output from the backlight source when all of the pixel circuits have been activated by the scan driver within the frame interval.

According to another aspect of the invention, there is provided a backlight driving method to be implemented by a backlight driving circuit for controlling operation of a backlight source based on which a plurality of pixel circuits that are arranged in a matrix formation are able to emit light. The backlight driving method comprises the steps of:

configuring the backlight driving circuit to adjust a backlight driving signal for the backlight source such that the backlight source is deactivated when at least one of the pixel circuits is yet to be activated within a frame interval; and

configuring the backlight driving circuit to adjust a duty cycle of the backlight driving signal to gradually increase brightness of light output from the backlight source when all of the pixel circuits have been activated within the frame interval.

### BRIEF DESCRIPTION OF THE DRAWINGS

Other features and advantages of the present invention will become apparent in the following detailed description of the preferred embodiment with reference to the accompanying drawings, of which:

FIG. 1 is a block diagram of the preferred embodiment of a backlight driving circuit in an operative relationship with a data processor, a plurality of pixel circuits, and a backlight source, according to the present invention;

FIG. 2 is a timing diagram of the backlight driving circuit;

FIG. 3 is a flowchart showing steps of the preferred embodiment of a backlight driving method according to the present invention; and

FIG. 4 is a timing diagram of a modification of the backlight driving circuit of the preferred embodiment.

### DETAILED DESCRIPTION OF THE PREFERRED EMBODIMENT

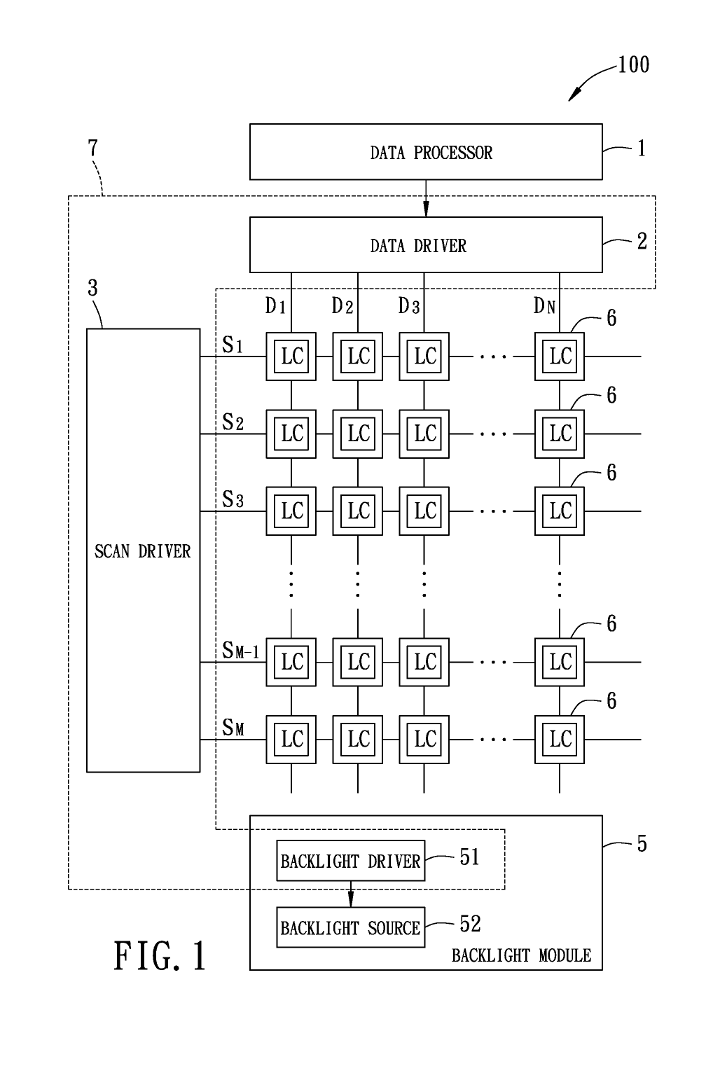

Referring to FIG. 1, the preferred embodiment of a backlight driving circuit 7 according to the present invention is for use in a display system 100 including a data processor 1, a backlight module 5 that includes a backlight source 52, a plurality of pixel circuits 6 that are arranged in a M×N matrix formation, a plurality (M) of scanning lines (S₁-S_{M}), and a plurality (N) of data lines (D₁-D_{N}). Each of the scanning lines (S₁-S_{M}) is connected electrically to the pixel circuits 6 in a corresponding row of the matrix formation. Each of the data lines (D₁-D_{N}) is connected electrically to the pixel circuits 6 in a corresponding column of the matrix formation. The backlight driving circuit 7 includes a data driver 2, a scan driver 3, and a backlight driver 51. The backlight driver 51 may be implemented as a component of the backlight module 5.

The data processor 1 is adapted for receiving image information, which may correspond to a sequence of images, and is configured to generate a data voltage for each of the pixel circuits 6 according to the image information received by the data processor 1.

The data driver 2 is connected electrically to the data processor 1 for receiving the data voltages therefrom, and is further connected electrically to the data lines (D₁-D_{N}) for providing the data voltages to the data lines (D₁-D_{N}), respectively.

The scan driver 3 is connected electrically to the scan lines (S₁-S_{M}), and is configured to activate the pixel circuits 6 in a row-by-row manner (i.e., the rows of the matrix formation are sequentially activated) within a frame interval for provision of the data voltages through the data lines (D₁-D_{N}) to the pixel circuits 6 in each row of the matrix formation by the data driver 2, respectively.

Thus, the pixel circuits 6 altogether display content of each image to which the image information corresponds.

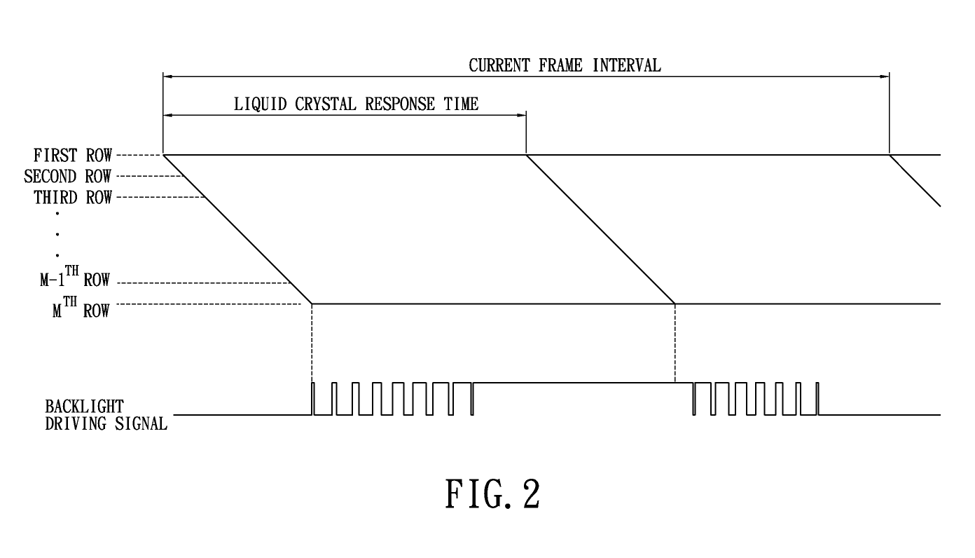

A skilled artisan may readily appreciate that each row of the pixel circuits 6 is activated at every frame interval of 16.7 ms. When the pixel circuits 6 are activated, a twist angle of a liquid crystal particle (LC) operatively associated with each of the pixel circuits 6 changes according to the corresponding data voltage received by the pixel circuit 6 from the data driver 2. Referring to FIG. 2, this change of twist angle may require a period of liquid crystal response time for completion. In an ideal scenario, the pixel circuits 6 have a same liquid crystal response time and the time point of completion of twist angle adjustment increases with the row number as a result of sequential activation of the rows of the matrix formation.

The backlight driver 51 is connected electrically to the backlight source 52, and is configured to adjust a duty cycle of a backlight driving signal for controlling operation of the backlight source 52. Control of light emission of the backlight source 52 is crucial in achieving high-quality presentation of the image information by the pixel circuits 6.

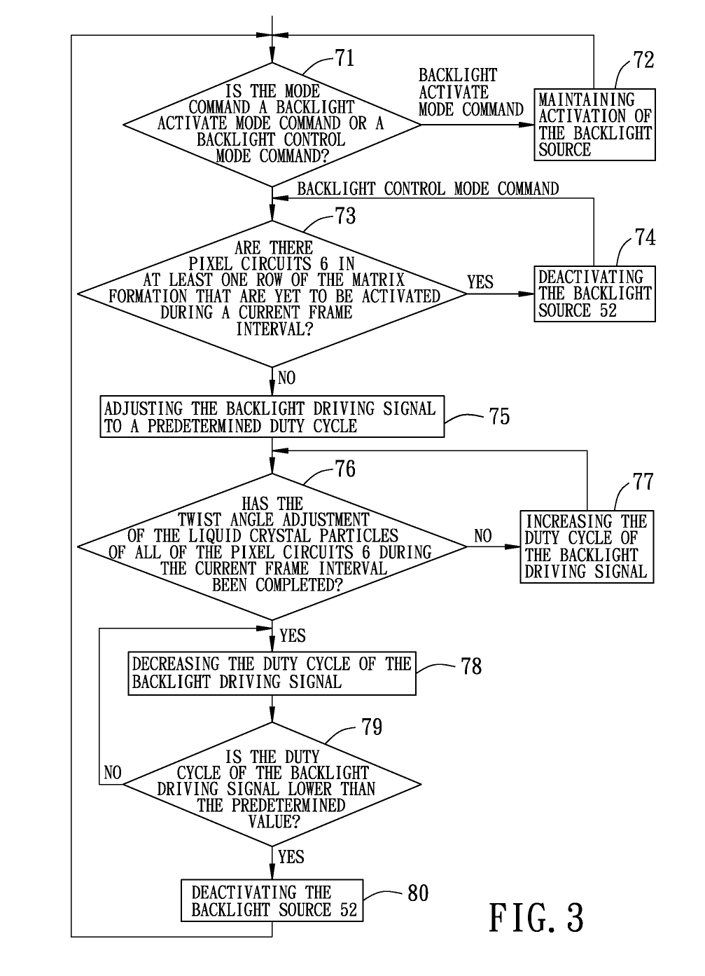

Referring to FIG. 3, the backlight driver 51 is configured to perform the preferred embodiment of a backlight driving method according to the present invention.

In step 70, the backlight driver 51 is configured to proceed to step 71 upon receipt of a mode command.

In step 71, the backlight driver 51 is configured to proceed to step 72 when the mode command is a backlight activate mode command, and to step 73 when the mode command is a backlight control mode command.

In step 72, the backlight driver 51 is configured to maintain the backlight driving signal at a high logic state to maintain activation of the backlight source 52, and the flow goes back to step 71. The backlight driving signal has 100% duty cycle (a maximum duty cycle of the backlight driving signal) at this time.

In step 73, the backlight driver 51 is configured to inspect whether there are pixel circuits 6 in at least one row of the matrix formation that are yet to be activated during a current frame interval (i.e., whether the pixel circuits 6 in the M-th row of the matrix formation are yet to be activated), to proceed to step 74 if affirmative, and to proceed to step 75 if otherwise.

In step 74, the backlight driver 51 is configured to force the backlight driving signal to a low logic state so as to deactivate the backlight source 52, and the flow goes back to step 73. The backlight driving signal has 0% duty cycle at this time.

In step 75, the backlight driver 51 is configured to adjust the backlight driving signal to a predetermined duty cycle, such as 25%. Preferably, the period of the backlight driving signal is much smaller than one frame interval. The flow then proceeds to step 76.

In step 76, the backlight driver 51 is configured to inspect whether the twist angle adjustment of the liquid crystal particles of all of the pixel circuits 6 during the current frame interval has been completed (i.e., whether the liquid crystal response time has elapsed after the pixel circuits 6 in row S_{M} have been activated), to proceed to step 78 if affirmative, and to proceed to step 77 if otherwise.

In step 77, the backlight driver 51 is configured to increase the duty cycle of the backlight driving signal, and the flow goes back to step 76.

In step 78, the backlight driver 51 is configured to decrease the duty cycle of the backlight driving signal, and the flow goes to step 79.

In step 79, the backlight driver 51 is configured to inspect whether the duty cycle of the backlight driving signal is lower than the predetermined value (i.e., lower than 25%), to proceed to step 80 if affirmative, and to go back to step 78 if otherwise.

In step 80, the backlight driver 51 is configured to force the backlight driving signal to have 0% duty cycle so as to deactivate the backlight source 52, and the flow goes back to step 71 for adjustment of the backlight driving signal during a next frame interval.

Accordingly, the backlight source 52 is activated only after the pixel circuits 6 in the M-th row of the matrix formation have been activated. Further, after the backlight source 52 is activated, brightness of light output of the backlight source 52 is gradually increased until adjustment of the twist angle of each of the pixel circuits 6 in the M-th row of the matrix formation is completed. The brightness of the light output of the backlight source 52 is decreased thereafter. In comparison with the aforesaid method of the prior art, which is known to cause image flickering, activation of the backlight source 52 is not limited to be not within the liquid crystal response time, which may effectively reduce image flickering. Furthermore, through adjusting the duty cycle of the backlight driving signal, adjustment of the brightness of the light output of the backlight source 52 may be achieved, thereby minimizing interference of a previous image on a current image so as to inhibit residual image.

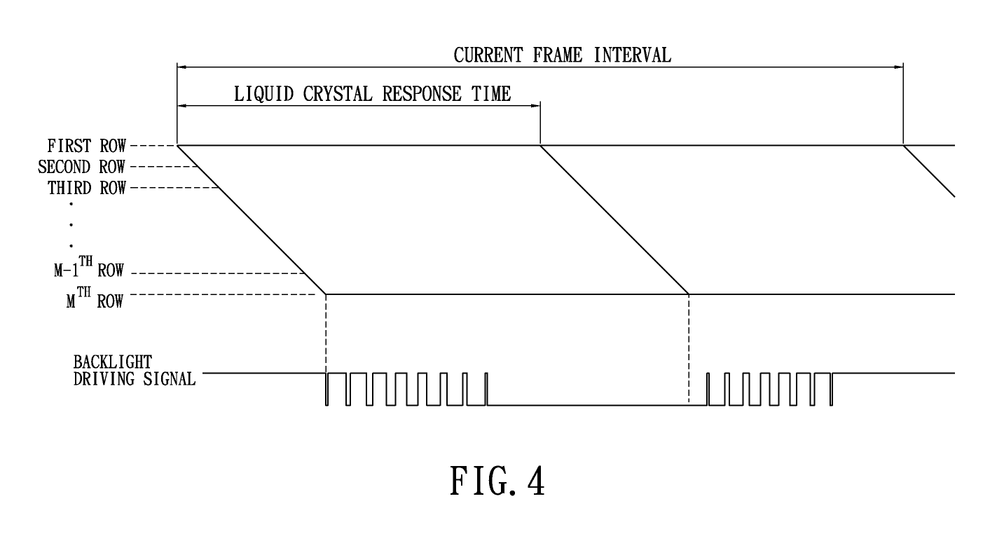

In the present embodiment, the backlight source 52 emits light when the backlight driving signal is at the high logic state. In a modification, referring to FIG. 4, the backlight source 52 may be configured to emit light when the backlight driving signal is at the low logic state. It is evident from FIG. 4 that the backlight driving signal in such a modification is a complement of the backlight driving signal shown in FIG. 2.

In summary, the backlight driving circuit 7 of this invention is capable of alleviating both image flickering and residual image phenomenon through appropriate adjustment of the duty cycle of the backlight driving signal to allow for light emission by the backlight source 52 during twist angle adjustment of liquid crystal particles and to allow gradual change in the brightness of the light output of the backlight source 52.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A backlight driving circuit adapted for receiving a plurality of data voltages and adapted to be connected electrically to a backlight source and to a plurality of pixel circuits that are arranged in a matrix formation, said backlight driving circuit comprising:
a scan driver configured to be operatively associated with the pixel circuits and configured to activate the pixel circuits in a row-by-row manner within a frame interval for provision of the data voltages to the pixel circuits in each row of the matrix formation, respectively; and
a backlight driver configured to be operatively associated with the backlight source, configured to adjust a duty cycle of a backlight driving signal for the backlight source such that the backlight source is deactivated when at least one of the pixel circuits is yet to be activated by said scan driver within the frame interval, and configured to adjust the duty cycle of the backlight driving signal to gradually increase brightness of light output from the backlight source when all of the pixel circuits have been activated by said scan driver within the frame interval.

2. The backlight driving circuit as claimed in claim 1, further comprising a data driver adapted for receiving the data voltages and adapted to be connected electrically to the pixel circuits for respectively providing the data voltages to the pixel circuits in the row of the matrix formation being activated by said scan driver.

3. The backlight driving circuit as claimed in claim 1, each of the pixel circuits being operatively associated with a liquid crystal particle for adjusting a twist angle thereof according to the corresponding data voltage,
wherein said backlight driver is further configured to adjust the duty cycle of the backlight driving signal to gradually reduce the brightness of the light output from the backlight source when adjustment of the twist angles of the liquid crystal particles by the corresponding pixel circuits is complete.

4. The backlight driving circuit as claimed in claim 1, wherein said backlight driver is further configured to adjust the duty cycle of the backlight driving signal to gradually reduce the brightness of the light output from the backlight source subsequent to elapse of a predetermined liquid crystal response time after all of the pixel circuits have been activated by said scan driver within the frame interval.

5. The backlight driving circuit as claimed in claim 4, each of the pixel circuits being operatively associated with a liquid crystal particle for adjusting a twist angle thereof according to the corresponding data voltage,
wherein the liquid crystal response time is a time required to twist the angle of the liquid crystal particle associated with each of the pixel circuits according to the corresponding data voltage.

6. The backlight driving circuit as claimed in claim 5, wherein said backlight driver is configured to decrease the duty cycle of the backlight driving signal to reduce the brightness of the light output from the backlight source, and
wherein said backlight driver is configured to force the backlight driving signal to a low logic state so as to deactivate the backlight source when the duty cycle of the backlight driving signal has been decreased to a predetermined value.

7. The backlight driving circuit as claimed in claim 1, wherein:
in response to receipt of a backlight control mode command, said backlight driver is configured to adjust the duty cycle of the backlight driving signal based on activation of the pixel circuits within the frame interval; and
in response to receipt of a backlight activate mode command, said backlight driver is configured to maintain the backlight driving signal to activate the backlight source.

8. A backlight driving method to be implemented by a backlight driving circuit for controlling operation of a backlight source based on which a plurality of pixel circuits that are arranged in a matrix formation are able to emit light, said backlight driving method comprising the steps of:
configuring the backlight driving circuit to adjust a backlight driving signal for the backlight source such that the backlight source is deactivated when at least one of the pixel circuits is yet to be activated within a frame interval; and
configuring the backlight driving circuit to adjust a duty cycle of the backlight driving signal to gradually increase brightness of light output from the backlight source when all of the pixel circuits have been activated within the frame interval.

9. The backlight driving method as claimed in claim 8, further comprising the step of:
configuring the backlight driving circuit to adjust the duty cycle of the backlight driving signal to gradually reduce the brightness of the light output from the backlight source subsequent to elapse of a predetermined liquid crystal response time after all of the pixel circuits have been activated within the frame interval.

10. The backlight driving method as claimed in claim 9, each of the pixel circuits being operatively associated with a liquid crystal particle for adjusting a twist angle thereof according to a corresponding data voltage,
wherein the liquid crystal response time is a time required to twist the angle of the liquid crystal particle associated with each of the pixel circuits according to the corresponding data voltage.

11. The backlight driving method as claimed in claim 9, wherein the backlight driving circuit is configured to decrease the duty cycle of the backlight driving signal to reduce the brightness of the light output from the backlight source, said backlight driving method further comprising the step of:
configuring the backlight driving circuit to force the backlight driving signal to a low logic state so as to deactivate the backlight source when the duty cycle of the backlight driving signal has been decreased to a predetermined value.

12. The backlight driving method as claimed in claim 8, further comprising the steps of:
in response to receipt of a backlight control mode command, using the backlight driving circuit to adjust the duty cycle of the backlight driving signal based on activation of the pixel circuits within the frame interval; and
in response to receipt of a backlight activate mode command, using the backlight driving circuit to maintain the backlight driving signal to activate the backlight source.
